(19) United States
(12) Patent Application Publication
(10) Pub. No.: US 2005/0157231 A1
(43) Pub. Date: Jul. 21, 2005

(54) Transflective mode liquid crystal display

(75) Inventors: Chiu-Lien Yang, Miao-Li (TW); Chueh-Ju Chen, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/026,638

(22) Filed: Dec. 30, 2004

(30) Foreign Application Priority Data
Jan. 16, 2004 (TW) 93101195

(51) Int. Cl. G02F 1/1335; G02F 1/1343

(52) U.S. Cl. 349/114; 349/141

(57) ABSTRACT

A transflective mode liquid crystal display (2) includes a first substrate (211) and a second substrate (210), a liquid crystal layer (230) interposed between the first substrate and the second substrate, a plurality of pixel electrodes (213) and a plurality of counter electrodes (212) formed on the first substrate, a color filter (250) disposed on an inner surface of the second substrate, and a transflective element (271) disposed on the first substrate. The color filter has a color resin layer, which comprises a transmission section and a reflection section. Brightness and color saturation of light beams emitted from the transmission section are substantially the same as those of light beams emitted from the reflection section. Therefore, the transflective mode liquid crystal display has improved color and brightness characteristics.

### BACKGROUND OF THE INVENTION

1. Field of the Invention

The present invention relates to transflective mode liquid crystal displays, and particularly to a transflective mode liquid crystal display with improved color and brightness characteristics.

2. Description of Prior Art

The in-plane switching liquid crystal display (IPS-LCD) has been developed in order to improve the narrow viewing angle of the more traditional twisted nematic liquid crystal display (TN-LCD). The IPS-LCD has a plurality of counter electrodes and a plurality of pixel electrodes all disposed on a same substrate of two opposite substrates, for driving liquid crystal molecules in a liquid crystal layer between the two substrates. The resulting electric field is substantially planar and parallel to surfaces of both substrates. This configuration provides an improved viewing angle.

Referring to FIG. 6, this is a cross-sectional view of a conventional transflective mode IPS-LCD 1. The IPS-LCD 1 comprises an upper substrate 10 and a lower substrate 11 disposed opposite to each other and spaced apart a predetermined distance, with a liquid crystal layer (not labeled) having a plurality of liquid crystal molecules 30 disposed therebetween. A transflective element 171 having a reflection section 1711 and a transmission section 1712 is disposed on an inner side of the lower substrate 11. A plurality of counter electrodes 12 and a plurality of pixel electrodes 13 are disposed on the transflective element 171, with an insulating layer 60 and an alignment film 41 disposed on the counter and pixel electrodes 12, 13, in that order from bottom to top. A lower polarizer 21 is formed on an undersurface of the lower substrate 11, and an upper polarizer 20 is formed on a top surface of the upper substrate 10. A color filter 50 and an alignment film 40 are disposed on an undersurface of the upper substrate 10, in that order from top to bottom.

Referring to FIG. 7, this is an enlarged, inverted view of part of a color filter 250 of the conventional transflective mode IPS LCD 1. The color filter 50 comprises a transparent substrate 501, a black matrix (not shown), and a color resin layer 502 having Red, Green and Blue segments. The color resin layer 502 has a transmission section T corresponding to the transmission section 1712 of the transflective element 171, and a reflection section R corresponding to the reflection section 1711 of the transflective element 171. The transmission section T and the reflection section R have a same thickness.

When the IPS-LCD 1 is driven, an electric field having a component parallel to two main surfaces of the substrates 10, 11 is formed at upper portions of the counter electrodes 12 and the pixel electrodes 13. In the transmission section T of the color filter 50, light beams emitted from a backlight (not shown) pass through the color resin layer 502 and the transparent substrate 501 to display color images. In the reflection section R of the color filter 50, light beams incident from an exterior of the IPS-LCD 1 pass through the transparent substrate 501 and the color resin layer 502, and are then reflected by the reflection section 1711 of the transflective element 171. The reflected light beams pass back through the color resin layer 502 and the transparent substrate 501 again to display color images.

As described above, light beams pass through the color resin layer 502 twice in the reflection section R and once only in the transmission section T. Therefore, when the reflection section R and the transmission section T have the same thickness, the light beams emitted from the reflection section R have a lower brightness than those of the transmission section T, because the distance traveled by the light beams passing through the color resin layer 502 in the reflection section R is longer than that in the transmission section T. That is, much more light energy is lost in the reflection section R than in the transmission section T.

Furthermore, the color characteristics of the light beams emitted from the reflection section R are different from the color characteristics of the of light beams emitted from the transmission section T. In particular, the color saturation of the light beams emitting from the reflection section R is more than the color saturation of the light beams emitting from the transmission section T.

It is desired to provide a transflective mode liquid crystal display that can solve the above-mentioned brightness and color problems.

### SUMMARY OF THE INVENTION

An object of the present invention is to provide a transflective mode liquid crystal display which has enhanced brightness and color characteristics.

Another object of the present invention is to provide a transflective mode liquid crystal display having a wide viewing angle.

To achieve the above objects, a transflective mode liquid crystal display comprises a first substrate and a second substrate disposed opposite each other and spaced apart a predetermined distance, a liquid crystal layer interposed between the first substrate and the second substrate, a plurality of pixel electrodes and a plurality of counter electrodes formed on the first substrate, a color filter disposed on an inner surface of the second substrate, and a transflective element disposed on the first substrate. The color filter has a color resin layer, which comprises a transmission section and a reflection section. Brightness and color saturation of light beams emitted from the transmission section are substantially the same as those of light beams emitted from the reflection section. Therefore, the transflective mode liquid crystal display has improved color and brightness characteristics.

Other objects, advantages, and novel features of the present invention will become more apparent from the following detailed description when taken in conjunction with the accompanying drawings, in which:

### BRIEF DESCRIPTION OF THE DRAWINGS

FIG. 1 is a schematic, cross-sectional view of part of a transflective mode liquid crystal display according to a first embodiment of the present invention;

FIG. 2 is an enlarged, inverted view of part of a color filter of the transflective mode liquid crystal display of FIG. 1;

FIG. 3 is similar to FIG. 2, but showing an alternative color filter according to the present invention;

FIG. 4 is similar to FIG. 2, but showing a further alternative color filter according to the present invention;

FIG. 5 is a schematic, cross-sectional view of part of a transflective mode liquid crystal display according to a second embodiment of the present invention;

FIG. 6 is a schematic, cross-sectional view of part of a conventional transflective mode IPS LCD; and

FIG. 7 is an enlarged, inverted view of part of a color filter of the conventional transflective mode IPS LCD of FIG. 6.

### DETAILED DESCRIPTION OF THE INVENTION

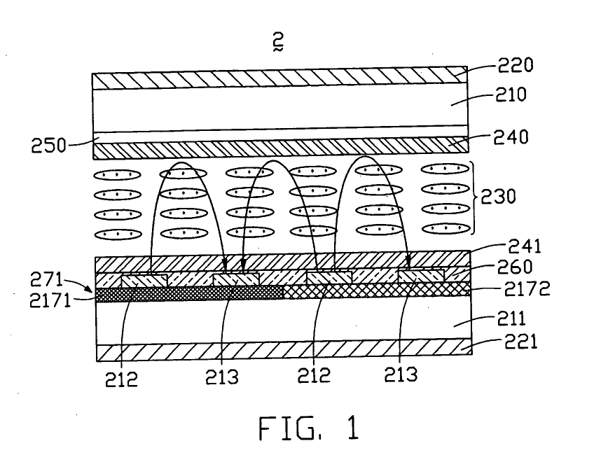

FIG. 1 is a schematic, cross-sectional view of a transflective mode liquid crystal display 2 according to the first embodiment of the present invention. The transflective mode liquid crystal display 2 comprises a first substrate 211, a second substrate 210, and a liquid crystal layer 230 having a plurality of liquid crystal molecules. The first substrate 211 and the second substrate 210 are spaced apart from each other, and the liquid crystal layer 230 is disposed therebetween.

A plurality of gate bus lines (not shown) and a plurality of data bus lines (not shown) are cross-arranged on an inner surface of the first substrate 211. A plurality of thin film transistors (not shown) is disposed at intersections of the gate bus lines and the data bus lines. A plurality of counter electrodes 212 and a plurality of pixel electrodes 213 are disposed on the first substrate 211, with a transparent insulating layer 260 and an alignment film 241 disposed on the counter and pixel electrodes 212, 213 in that order from bottom to top. A transflective element 271 is interposed between the counter and pixel electrodes 212, 213 and the first substrate 211. A color filer 250 and an alignment film 240 are formed on an underside of the second substrate 210, in that order from top to bottom. Two polarizers 221, 220 are formed on two outer surfaces of the first substrate 211 and the second substrate 210, respectively.

The alignment films 241, 240 are horizontal alignment layers. Alignment directions of the alignment films 241, 240 are parallel to each other, or alternatively an angle of 180 degrees may be defined between the alignment directions. Polarization axes of the polarizers 221, 220 are perpendicular to each other.

The counter electrodes 212 and the pixel electrodes 213 are strip-shaped, and are arranged parallel to each other in alternating fashion on the transflective element 271. The counter electrodes 212 and the pixel electrodes 213 are made of a transparent conductor, such as indium tin oxide (ITO) or indium zinc oxide (IZO). The transflective element 271 is made of a dielectric material. When a voltage is applied to the counter electrodes 212 and the pixel electrodes 213, an electric field having horizontal components is produced therebetween. Long axes of the liquid crystal molecules are aligned parallel to the direction of the electric field. Alternatively, the counter electrodes 212 and the pixel electrodes 213 may be zigzag-shaped, or wave-shaped.

The transflective element 271 has a reflection section 2171 and a transmission section 2172. The combination of the reflection section and transmission sections 2171, 2172 corresponds to a single pixel. The reflection section 2171 is made of a plurality of layers of high-reflectivity dielectric materials stacked one on the other, for reflecting light beams incident from an exterior of the transflective mode liquid crystal display 2. The transmission section 2172 is made of a plurality of layers of high-transmission dielectric materials stacked one on the other, for transmitting light beams emitted from a backlight (not shown) disposed under the first substrate 211.

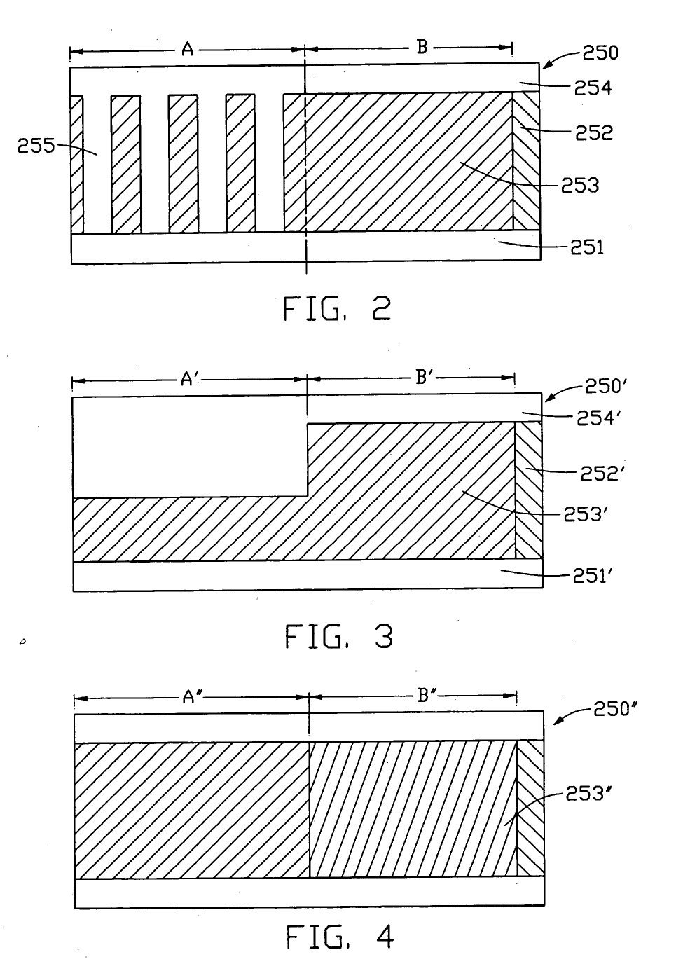

Referring to FIG. 2, the color filter 250 includes a transparent substrate 251, and a black matrix 252, a color resin layer 253 and a transparent protection layer 254 that are all formed on the transparent substrate 251.

The color resin layer 253 comprises a plurality of RGB (Red Green Blue) segments. Each RGB segment comprises a Red (R) segment, a Green (G) segment, and a Blue (B) segment. The RGB segments are arranged in a regular repeating array on the transparent substrate 251. The black matrix 252 is disposed between the RGB segments, for preventing light beams from leaking and for protecting the thin film transistors from damage. The transparent protection layer 254 is coated on the color resin layer 253 and the black matrix 252, and is made of SiO₂ (silicon dioxide) or SiNx (silicon nitride). Each RGB segment of the color resin layer 253 is divided into a reflection section/area A and a transmission section/area B, corresponding to the reflection section 2171 and the transmission section 2172 of the transflective element 271, respectively. A thickness of the color resin layer 253 of the reflection section A is equal to that of the transmission section B. The reflection section A defines a plurality of grooves 255 therein, which are areas having no color resin and which are filled with the transparent protection layer 254. Portions of the reflection section A corresponding to the grooves 255 are non-color portions, and the other portions of the reflection section A are color portions. The combined area of the non-color portions is equal to that of the color portions.

Operation of the color filter 250 of the transflective mode liquid crystal display 2 is as follows. In the transmission section B, light beams emitted from the backlight transmit through the transparent protection layer 254, the color resin layer 253 and the transparent substrate 251 in a single pass to display images. In this case, a color is expressed by a color resin contained in the color resin layer 253, and brightness is adjusted by controlling the voltage applied to the counter electrodes 212 and the pixel electrodes 213.

In the reflection section A, light beams incident from the exterior pass through the transparent substrate 251, the color resin layer 253 and the transparent protection layer 254, and are then reflected by the reflection section 2171 of the transflective element 271. The reflected light beams pass back through the transparent protection layer 254, the color resin layer 253 and the transparent substrate 251 to display images. In this case also, a color is expressed by the color resin contained in the color resin layer 253, and brightness is adjusted by controlling the voltage applied to the counter electrodes 212 and the pixel electrodes 213.

That is, in the transmission section B, light beams pass through the color resin layer 253 once; while in the reflection section A, light beams pass through the color resin layer 253 twice. Because the grooves 255 have no color resin filled therein, and the combined area of the non-color portions is equal to that of the color portions, a distance for light beams to pass through the color portions of the reflection section A is substantially equal to that for light beams to pass through the transmission section B. Therefore, the brightness and the color of the reflection section A are properly adjusted. As a result, the reflection section A and the transmission section B of the color resin layer 253 have substantially the same levels of brightness and color saturation.

Furthermore, the transflective mode liquid crystal display 2 is an IPS LCD, which yields a wide viewing angle.

In the first embodiment of the transflective mode liquid crystal display 2 of the present invention, a plurality of holes (not shown) can be provided in the reflection section A instead of the grooves 255. The holes can be cylindrical with polygonal ends, or cylindrical with circular ends. The transparent protection layer 254 is filled into the holes.

FIG. 3 illustrates an alternative color filter 250′ according to the present invention. The color filter 250′ is similar to the color filter 250, and includes a transparent substrate 251′, a black matrix 252′, a color resin layer 253′ and a transparent protection layer 254′. The color resin layer 253′ comprises a plurality of RGB segments. Each RGB segment has a reflection section A′ and a transmission section B′. A thickness of the color resin layer 253′ in the reflection section A′ is half that of the color resin layer 253′ in the transmission section B′. Therefore a distance for light beams to pass through the reflection section A′ of the color resin layer 253′ twice is substantially equal to that for light beams to pass through the transmission section B′ of the color resin layer 253′ once. In other words, the brightness and the color saturation of the light beams emitting from the reflection section A′ is substantially the same as that of the light beams emitting from the transmission section B′.

FIG. 4 illustrates a further alternative color filter 250″ according to the present invention. The color filter 250″ is similar to the color filters 250 and 250′. A thickness of a color resin layer 253″ in each reflection section A″ is equal to that of the color resin layer 253″ in each transmission section B″. A concentration of color resin in the reflection section A″ is half of a concentration of color resin in the transmission section B″.

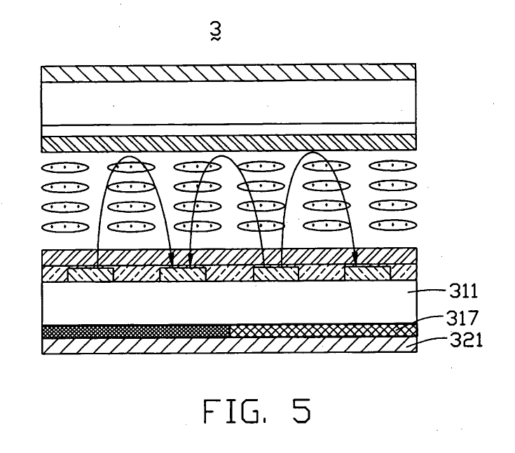

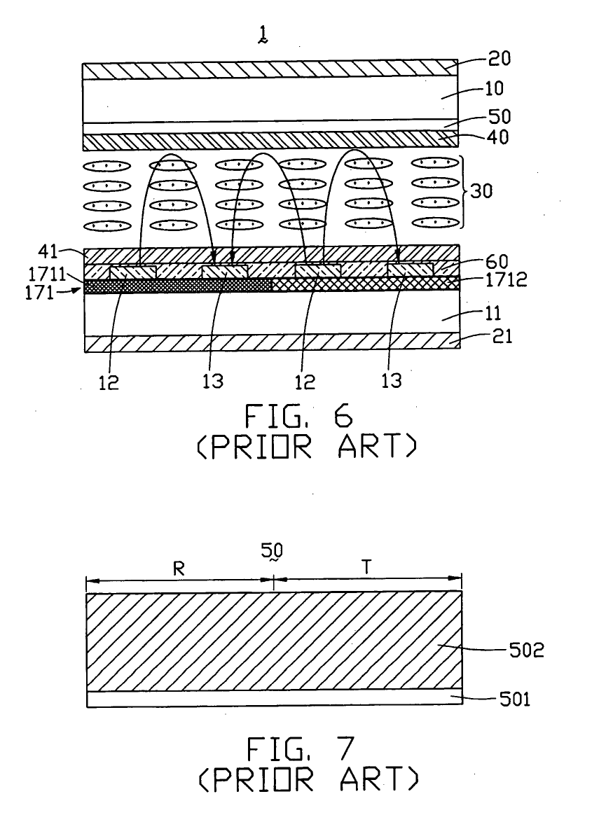

Referring to FIG. 5, this is a schematic, cross-sectional view of a transflective mode liquid crystal display 3 according to the second embodiment of the present invention. The transflective mode liquid crystal display 3 is similar to the transflective mode liquid crystal display 2 of the first embodiment, and comprises a first substrate 311, a transflective element 317 and a polarizer 321. The transflective element 317 is interposed between the first substrate 311 and the polarizer 321.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

1. A transflective mode liquid crystal display comprising:
a first substrate and a second substrate disposed opposite each other and spaced apart a predetermined distance;
a liquid crystal layer interposed between the first substrate and the second substrate;
a plurality of pixel electrodes and a plurality of counter electrodes formed on the first substrate;
a color filter disposed on an inner surface of the second substrate, the color filter having a color resin layer, which comprises a transmission section and a reflection section; and
a transflective element disposed adjacent the first substrate;
wherein a brightness and a color saturation of light beams emitted from the transmission section are substantially the same as a brightness and a color saturation of light beams emitted from the reflection section.

2. The transflective mode liquid crystal display as claimed in claim 1, wherein the pixel electrodes and the counter electrodes are strip-shaped, zigzag shaped, or wave-shaped.

3. The transflective mode liquid crystal display as claimed in claim 2, wherein the transflective element has a transmission section and a reflection section corresponding to the transmission section and the reflection section of the color resin layer, respectively.

4. The transflective mode liquid crystal display as claimed in claim 3, wherein the transflective element is made of a dielectric material.

5. The transflective mode liquid crystal display as claimed in claim 4, wherein the reflection section of the transflective element is made of a plurality of layers of high reflectivity materials stacked one on the other, and the transmission section of the transflective element is made of a plurality of layers of high transmission materials stacked one on the other.

6. The transflective mode liquid crystal display as claimed in claim 2, wherein the reflection section of the color resin layer has a plurality of grooves, and an area of the grooves is substantially equal to an area of the color resin in the reflection section of the color resin layer.

7. The transflective mode liquid crystal display as claimed in claim 5, wherein the reflection section of the color resin layer has a plurality of grooves, and an area of the grooves is substantially equal to an area of the color resin in the reflection section of the color resin layer.

8. The transflective mode liquid crystal display as claimed in claim 2, wherein the reflection section of the color resin layer has a plurality of holes.

9. The transflective mode liquid crystal display as claimed in claim 5, wherein said reflection section of the color resin layer has a plurality of holes.

10. The transflective mode liquid crystal display as claimed in claim 9, wherein the holes are cylindrical with polygonal ends or cylindrical with circular ends.

11. The transflective mode liquid crystal display as claimed in claim 2, wherein a thickness of the color resin layer at the reflection section thereof is substantially half a thickness of the color resin layer at the transmission section thereof.

12. The transflective mode liquid crystal display as claimed in claim 5, wherein a thickness of the color resin layer at the reflection section thereof is substantially half a thickness of the color resin layer at the transmission section thereof.

13. The transflective mode liquid crystal display as claimed in claim 2, wherein a thickness of the color resin layer at the reflection section thereof is substantially equal to a thickness of the color resin layer at the transmission section thereof, and a concentration of color resin in the reflection section of the color resin layer is substantially half a concentration of color resin in the transmission section of the color resin layer.

14. The transflective mode liquid crystal display as claimed in claim 5, wherein a thickness of the color resin layer at the reflection section thereof is substantially equal to a thickness of the color resin layer at the transmission section thereof, and a concentration of color resin in the reflection section of the color resin layer is substantially half a concentration of color resin in the transmission section of the color resin layer.

15. The transflective mode liquid crystal display as claimed in claim 1, wherein an electric filed is provided to have horizontal components parallel to the first substrate.

16. A transflective mode liquid crystal display comprising:
a first substrate and a second substrate disposed opposite each other and spaced apart a predetermined distance;
a liquid crystal layer interposed between the first substrate and the second substrate;
a plurality of pixel electrodes and a plurality of counter electrodes formed on the first substrate;
a color filter disposed on an inner surface of the second substrate, the color filter having a color resin layer, which comprises a transmission area and a reflection area;
a transflective element disposed adjacent the first substrate with a transmission section and a reflection section essentially aligned with the corresponding transmission area and the reflection area, respectively; and
means for keeping a brightness and a color saturation of light beams emitted from the transmission area substantially the same as a brightness and a color saturation of light beams emitted from the reflection area.

17. A transflective mode liquid crystal display comprising:
a first substrate and a second substrate disposed opposite each other and spaced apart a predetermined distance;
a liquid crystal layer interposed between the first substrate and the second substrate;
a plurality of pixel electrodes and a plurality of counter electrodes formed on the first substrate;
a color filter disposed on an inner surface of the second substrate, the color filter having a color resin layer, which comprises a transmission area and a reflection area; and
a transflective element disposed adjacent the first substrate with a transmission section and a reflection section essentially aligned with the corresponding transmission area and the reflection area, respectively; wherein
either the transmission area and the reflection area of the color filter or the transmission section and the reflection section of the transflective element is arranged different from each other either dimensionally or characteristically to keep a brightness and a color saturation of light beams emitted from the transmission area substantially the same as a brightness and a color saturation of light beams emitted from the reflection area.
